(19) United States
(12) Patent Application Publication
(10) Pub. No.: US 2023/0193667 A1
(43) Pub. Date: Jun. 22, 2023

(54) ELECTRONIC HANDLE FOR A VEHICLE DOOR

(71) Applicant: U-Shin Italia S.p.A., Pianezza (IT)

(72) Inventors: Thomas DEVERNOIS, Pianezza (IT); Anthony GUERIN, Pianezza (IT)

(73) Assignee: U-Shin Italia S.p.A., Pianezza (IT)

(21) Appl. No.: 18/082,807

(22) Filed: Dec. 16, 2022

(30) Foreign Application Priority Data
Dec. 16, 2021 (EP) 21215308.4

(51) Int. Cl. E05B 81/90; E05B 85/16; E05B 81/64

(52) U.S. Cl. CPC E05B 81/90; E05B 81/64; E05B 85/16

(57) ABSTRACT

A vehicle handle includes a grip member, electronic device, bracket, and retainer. The grip member cooperates with an activation member to activate a latch and unlatch the door. The grip member and activation member are rotatably mounted respectively about grip and activation axes. The electronic device activates the latch. The retainer is mounted on the bracket to rotate around a retaining axis and has a predetermined retaining force. The grip, activation, and retaining axes are parallel to each other. The activation member comprises a driving element and the retaining member comprises a stop element. The driving element cooperates with the stop element such that when the grip member is pulled from the rest position to the mechanical activation position, the activation member is actuated according to a driving force. The driving element contacts the stop element and is retained thereby until the driving force exceeds the predetermined retaining force.

### CROSS-REFERENCE TO RELATED APPLICATIONS

This application claims priority to and the benefit of European application number 21215308.4 filed on Dec. 16, 2021. The disclosures of the above application are incorporated herein by reference.

### FIELD

The present disclosure relates to an electronic handle for a vehicle door and a vehicle comprising such a handle.

### BACKGROUND

The statements in this section merely provide background information related to the present disclosure and may not constitute prior art.

Electronic handles for vehicle doors generally comprise a switch configured to activate a latch mechanism, such as an electronic latch, to unlock the vehicle door.

Some customers prefer having an electronic handle with a grip member configured to be actuated by a user according to a reduced stroke with respect to classical mechanical handles, thereby activating the electronic latch mechanism.

Such electronic handles require a power supply to be useable. In case of loss of energy in the battery, the typical electronic handle is not useable and it is not possible for a user to enter the vehicle.

Thus, there is a need for a mechanical back-up system enabling to unlatch the vehicle door when there is not enough energy in the battery for the electronic latch mechanism to function. In general, a mechanical system usually comprises a grip member cooperating with an activation member which in turn cooperates with the latch mechanism.

### SUMMARY

This section provides a general summary of the disclosure and is not a comprehensive disclosure of its full scope or all of its features.

An object of the present disclosure is to provide an electronic handle with a mechanical back up in case of loss of battery which is efficient and easy for the user to activate.

In one form, the present disclosure provides for an electronic handle for a vehicle door. The electronic handle includes a grip member, an electronic device, a bracket, and a retaining member. The grip member is configured to cooperate with an activation member so as to activate a latch of the vehicle door and unlatch the door. The grip member and the activation member are rotatably mounted respectively about a grip axis and an activation axis. The electronic device configured to electronically activate the latch of the vehicle door. The grip member is configured to rotate between a rest position and a mechanical activation position. In the rest position, the activation member is released from the grip member. In the mechanical activation position, the grip member cooperates with the activation member to activate the latch of the vehicle door in case of default of the electronic device. The bracket is configured to receive the grip member and the activation member. The retaining member is mounted on the bracket to rotate around a retaining axis and has a predetermined retaining force. The grip axis, the activation axis, and the retaining axis are parallel to each other. The activation member comprises a driving element and the retaining member comprises a stop element. The driving element cooperates with the stop element such that when the grip member is pulled from the rest position to the mechanical activation position, the activation member is actuated according to a driving force. The driving element contacts the stop element and is retained by the stop element until the driving force exceeds the predetermined retaining force.

Advantageously, the electronic handle of the present disclosure provides a mechanical backup for opening the latch since the driving element and the stop element cooperate for the mechanical activation of the activation member. Therefore, the handle of the present disclosure has an efficient and easy to use mechanical backup.

Further, the mechanical backup is easy to mount with respect to the actuation member.

Moreover, the mechanical backup according to the present disclosure is able to provide a peak of load on the handle to activate the latch of the vehicle thanks to the predetermined retaining force of the stop element.

Advantageously, when the driving force exceeds the predetermined retaining force, the activation member is moved further to the mechanical activation position, the driving element passes the stop element and reaches the mechanical activation position.

According to further forms which can be used alone or in any possible combinations:
in the rest position, the activation member does not cooperate with the retaining member; and/or
when the activation member moves from the rest position through the mechanical activation position, the driving element is configured to engage the stop element according to a first path until the driving element is blocked by the stop element; and/or
when the driving force exceeds the predetermined retaining force, the driving element is configured to engage the stop element according to a second path, wherein the necessary driving force to move the activation member is less than the predetermined retaining force; and/or
the activation member further has an electrical activation position between the rest position and the mechanical activation position, in which the activation member activates the latch for unlatching the door; and/or
the stop element is configured to stop the activation member at or just after the electrical activation position; and/or
when the activation member is moved from the rest position to the electrical activation position by a control force, the stop element blocks the driving element at or after the electrical activation position; and/or
when the activation member moves by inertia or by a driving force lower than the predetermined retaining force from the mechanical activation position to the rest position, the driving element cooperates with the stop element such that the first path of the driving element engage the stop member; and/or
the stop element comprises a roller and the driving element comprises a surface configured to be in contact with the roller when the activation member moves from the rest position to the mechanical activation position; and/or
the roller having a curve surface, such as cylindrical surface, configured to be in contact with the driving element; and/or
the surface of the driving element is a cam surface having the first path and second path; and/or
the predetermined retaining force is provided by return retaining device associated with the retaining member; and/or
the stop element is moveable such that the driving element moves the stop element when moving from the rest position to the mechanical activation position; and/or
the stop element is free to rotate around a stopping axis parallel to the retaining axis when the driving element moves from the rest position to the mechanical activation position; and/or
the stop element rotates according to a rotation stopping axis when the driving element moves from the mechanical activation position to the rest position.

According to another form, the present disclosure provides for a vehicle comprising a door and the electronic handle, fixed to the door.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a front perspective view of an electronic handle according to the present disclosure;

FIG. 2 is a rear perspective view of the handle of FIG. 1;

FIG. 3 is top view of a handle member of the handle of FIG. 1, illustrated cooperating with an activation member of the handle;

FIG. 4 is a perspective view of a retaining member of the handle of FIG. 1, illustrated mounted in a bracket of the handle;

FIG. 5 is a side view of a portion of the handle of FIG. 1, illustrating the activation member in a rest position in accordance with the present disclosure;

FIG. 6 is a side similar to FIG. 5 but illustrating the activation member engaging the retaining member in accordance with the present disclosure;

FIG. 7 is a side view similar to FIG. 5 but illustrating the activation member blocked by the retaining member in an electrical activation position in accordance with the present disclosure; and

FIG. 8 is a side view similar to FIG. 5 but illustrating the activation member in a mechanical activation position, in particular for the pulling of a Bowden cable by a mechanical movement in accordance with the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

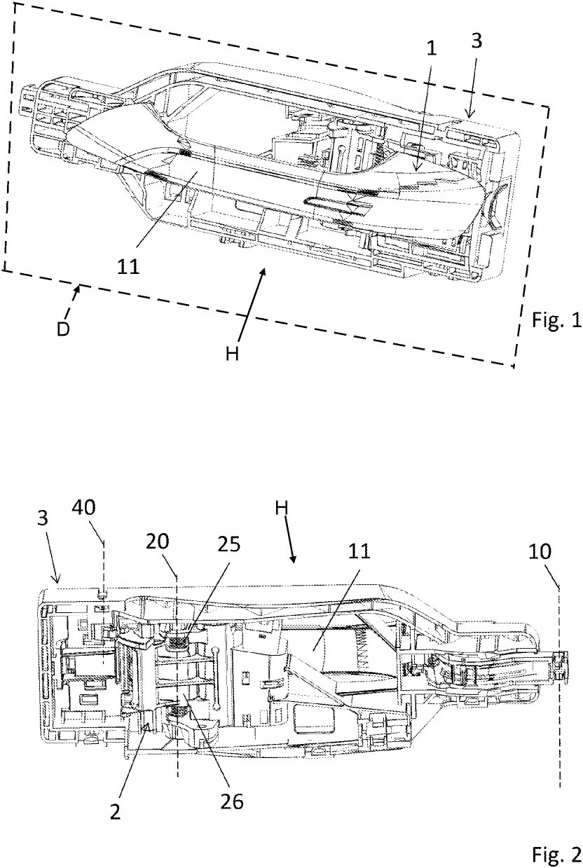

Referring to FIGS. 1 and 2, an electronic handle H may comprise a grip member 1 configured to be fixed in a vehicle door (a portion of which is schematically illustrated and indicated with reference numeral D). The grip member 1 is configured to be mounted on an exterior side of the vehicle door D. While one type of grip member is shown, the handle H of the present disclosure may have a different type of grip member or lever for activating the actuation member, described herein, which is rotatable according to a gripping axis 10.

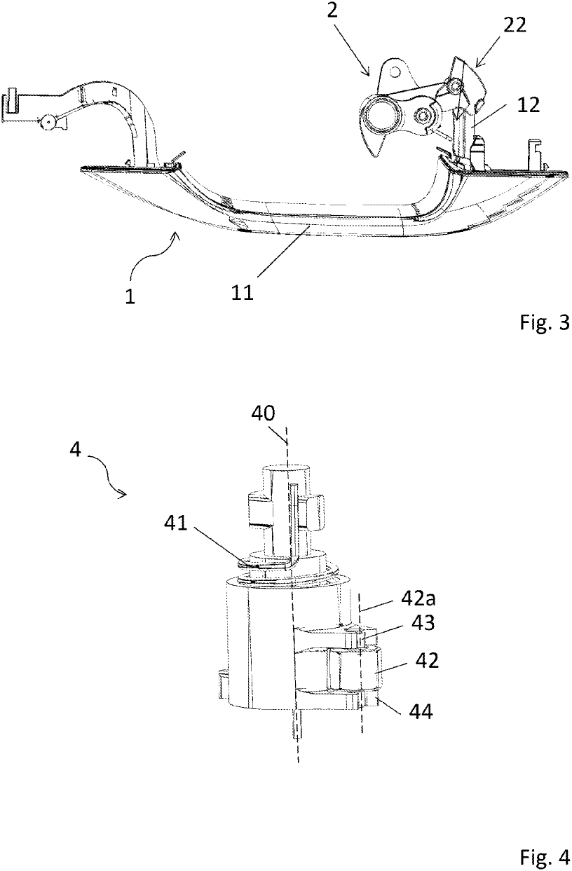

In one form, the grip member 1 may comprise a gripping part 11 configured to be grasped by a user, and pulled outwardly with respect to the vehicle door D when the user wants to open the door D. The grip member 1 further may comprise a column 12 (FIG. 3) connected to the gripping part 11 and projecting internally to the vehicle door D.

The handle H further comprises internal parts to be mounted at an interior side of the vehicle door D. The internal parts are generally mounted on a bracket 3 such that the bracket 3 supports the internal parts. In another form, a different supporting piece may be used with the handle H of the present disclosure.

Among the internal parts is an activation member 2 that cooperates with the grip member 1 through the column 12 (FIG. 3) such that when the grip member 1 is pulled, the grip member 1 drives the activation member 2 to move from a rest position to a mechanical activation position for activating a latch (not shown) for example by pulling mechanically a Bowden cable (not shown) . The activation member 2 is rotationally mounted about an activation axis 20. FIG. 2 shows the general aspect of the activation member 2, and FIG. 3 shows more details.

As an electronic handle, the handle H of the present disclosure comprises an electronic device configured to cooperate with the latch. The electronic device is configured to activate the latch through a signal to provide a control force for rotating the activation member 2. The latch in turn unlatches the vehicle door D.

The grip member 1 and/or the activation member 2 may be configured to electronically actuate the latch, for example by actuating a switch (not shown).

The electronic device may comprise the switch and a circuit (not shown) configured, for example, such that when the switch is closed, electric current flows and activates the latch.

The activation member 2 further has an electrical activation position between the rest position and the mechanical activation position, in which the activation member activates the electronic device to unlatch the door. The electronic device, in particular, the switch may be provided on the activation member 2 and/or on the grip member 11.

The electronic device can also be in contact with a surface of the activation member 2 or in contact with a moving element of the handle H connected to the activation member 2 and/or the grip member 1.

Alternatively, to the switch, a hall-effect device or a sensor may be used as an electronic device to command the latch.

According to one form, the grip member 1 and/or the activation member 2 may actuate the electronic device such as the switch, the hall-effect device or the sensor.

According to one form, the activation member 2 may be configured to be moved along a first stroke, preferably a short stroke, to reach the electrical activation position. The activation member 2 is further configured to be moved along a second stroke, preferably a long stroke, to reach the mechanical activation position. The mechanical activation position may be beyond the electrical activation position, and may be with the same orientation thereof, with reference to the rest position.

A retainer or retaining member 4 is mounted on the bracket 3 to rotate around a retaining axis 40. The retaining member 4 is mounted on the bracket 3 according to a predetermined retaining force to be fixed around the retaining axis 40. The retaining member 4 rotates when the predetermined retaining force is overcome to move between a projecting position and a retracted position.

The gripping axis 10, the activation axis 20 and the retaining axis 40 are parallel to each other. With additional reference to FIG. 4, the retaining member 4 comprises a stop element 42.

Advantageously, the gripping axis 10, the activation axis 20, and the stopping axis 42a are substantially parallel, which simplifies the displacement of the stop element 42 pushed by a driving element 22 and involves a gain of space.

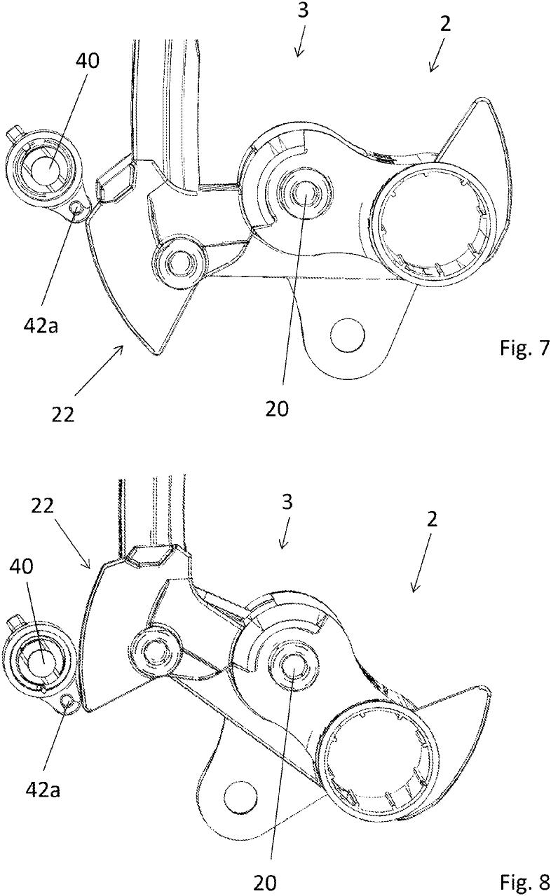

With additional reference to FIGS. 3-5, the activation member 2 comprises the driving element 22, and the retaining member 4 comprises the stop element 42, and the driving element 22 cooperates with the stop element 42 during their respective movements. More specifically, as shown in FIG. 7, when the activation member 2 is actuated from the rest position through the mechanical activation position, the driving element 22 is retained by the stop element 42 until the driving force exceeds (i.e., is greater than) the predetermined retaining force.

When the driving force exceeds the predetermined retaining force, the driving element 22 passes from a first side of the stop element 42 corresponding to an initial position, to a second side wherein the activation member 2 reaches the mechanical activation position corresponding to a final position. When the activation member 2 comes back from the mechanical activation position to the rest position, the driving element 22 and the stop element 42 cooperates for coming back in the initial position to the first side of the stop element 42.

The handle H of the present disclosure permits an improved mechanical backup in particular for electronic handles since the driving element 22 and the stop element 42 cooperate together such that the activation member 2 can reach the mechanical activation position and unlatch the door D.

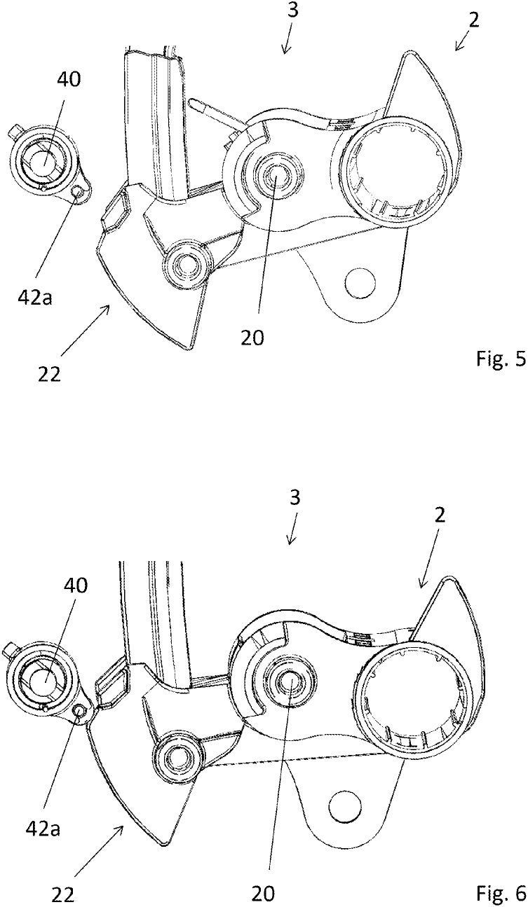

The rest position is shown in FIG. 5 and the mechanical activation position is shown in FIG. 8.

In the rest position, the activation member 2 is released from any actuation. The activation member 2 does not cooperate with the retaining member 4.

The handle H may be configured such that when the activation member 2 is moved from the rest position to the electrical activation position by a driving force, the stop element 42 engages the driving element 22 in an intermediate position between the initial and final positions, as shown in FIG. 6. The driving element 22 in the intermediate position may contact the stop element 42 and the stop element 42 slides on it.

Moreover, when the activation member 2 is moved further to the mechanical activation position by the driving force greater than the predetermined retaining force, the driving element 22 passes the stop element 42 as shown in FIG. 8. The driving element 22 then reaches the mechanical activation position.

In addition, when the activation member 2 moves by inertia or by a driving force lower than the predetermined retaining force from the mechanical activation position to the rest position, the driving element 22 cooperates with the stop element 42 for coming back to the rest position.

Advantageously, the handle H of the present disclosure permits an intermediate blocking position when the grip member is pulled with the driving force. This intermediate blocking position corresponds to or comes just after the electrical activation position of the electronic latch in particular by the activation member 2, and to a position of the activation member 2 as shown in FIG. 7. In this position, the activation is made by the activation member 2 associated to the switch, for example.

Referring to FIGS. 4-8, the stop element 42 is a roller and the driving element 22 comprises a surface configured to be in contact with the roller 42 when the activation member 2 moves from the rest position to the mechanical activation position. The roller 42 has a curve surface, such as cylindrical surface, in contact with the driving element 22.

The surface of the driving element 22 is a cam surface having a first path and second path.

During the first stroke of the activation member 2, the cam surface of the driving element 22 contacts the stop element 42 according to the first path.

During the second stroke of the activation member 2, the cam surface of the driving element 22 contacts the stop element 42 according to the second path.

Advantageously, when the driving element 22 is moving in contact with the roller 42 in order to pass the roller 42, the handle H needs an increased driving force.

The roller 42 may have a partial cylindrical shape. Advantageously, a partial cylindrical shape permits a wide stopping zone to be maintained effective even if the activation member 2 has play in the direction of the driving axis 20, i.e., is moved in rotation with respect to the plane of FIGS. 5-8.

The driving element 22 is placed at the first side of the stop element 42 and is configured to stop the driving element 22 when the activation member 2 is actuated with the driving force. This position is the one used to activate the electronic latch.

When the activation member 2 is actuated with the driving force, the cam surface of the driving element 22 is moved from the rest position such that the first path of the cam surface of driving element 22 engages the stop element 42.

Thus, the stop element 42 slides on the first path of the cam surface until the driving element reaches the electrical activation position, wherein the activation member 2 is stopped by the stop element 42.

The first path of the cam surface is increasing linearly so as to increase linearly the necessary driving force to move the activation member 2 until the necessary driving force exceeds the predetermined retaining force.

The end of the first path corresponds to the necessary driving force to overcome the predetermined retaining force, wherein a peak of load is required to reach go through the mechanical activation position.

When the driving force exceeds the predetermined retaining force, the activation member 2 passes the stop element 42, and the stop element 42 slides on the second path of the cam surface until the driving element reaches the mechanical activation position.

The second path of the cam surface is decreasing linearly from the end of the first path so as to linearly decrease the necessary driving force to move the activation member 2. The necessary driving force is thus less than the predetermined retaining force.

The end of the second path corresponds the mechanical activation position. This position is the one used to activate the mechanical backup.

The stop element 42 is moveable in rotation around the stopping axis 42a when the driving element 22 engages the stop element 42 and the driving element 22 moves from the rest position to the mechanical activation position. The retaining member 4 may be pushed by the driving element 22 such that the driving element 22 passes the stop element 42.

To this end, the stop element 42 is rotationally mounted onto the retaining member 4 about a stopping axis 42a parallel to the retaining axis 40.

The driving element 22 is associated with return driving device 25, for example a compression spring.

The return driving device 25 are supported by a base 26 of the activation member 2.

The return device 25 is configured to urge the driving element 22 towards the rest position.

Advantageously, the return driving device 25 permits an automatic mechanical returning of the driving element 22 to the rest position.

Moreover, in the arrangement of the example provided, the force of the return driving device 25 determines if the driving element 22 will pass the stop element 42 depending on the driving forces actuating the activation member 2. Thus, advantageously, the return driving device 25 permits calibration of the required force intensities for the first and second driving forces.

The driving element 22 may be a ball or a cylinder. Advantageously, the driving element 22 has a discontinuous curved surface and the stop element 42 is configured to roll on the driving element 22. A cylinder stop element 42 may be made of a plastic or a metallic material.

Advantageously, the rotation of the stop element 42 around the stopping axis 42a limits the frictional forces when the driving element 22 is moving on the stop element 42.

The driving element 22 may have the surface configured to be in contact with the stop element 42a covered by a layer reducing the friction between the driving element 22 and the stop element 42.

The stop element 42 is moveable such that the driving element 22 rotates the stop element 42 to pass the stop element 42.

To this end, the retaining member 4 is moveably mounted between a blocking position and a releasing position. In the blocking position, the retaining member 4 is placed such that the stop element 42 blocks the driving element 22 moving from the rest position to the mechanical activation position due to the driving force. In the releasing position, the retaining member 4 is moved in rotation around the retaining axis 40 by the driving element 22 such that the activation member 2 may go to the mechanical activation position.

Advantageously, due to the moveable stop element 42 and the arrangement of the first and second path, the activation member 2 is not blocked by the stop element 42 when returning from the mechanical activation position to the rest position.

The stop element 42 may rotate according to the stopping axis 42a when the driving element 22 moves from the rest position to the mechanical activation position. The rotation movement permits a simple displacement of the stop element 42 by the driving element 22.

To this end, the stop element 42 is supported by pins 43 extending along the stopping axis 42a to be clipped on notches 44 of the retaining member 4.

The retaining member 4 may be associated with return retaining device 41, such as a cylindrical spring providing the predetermined retaining force.

Advantageously, the return retaining device 41 permits an automatic mechanical returning of the stop element 42 to the blocking position. In addition, the return retaining device 41 permits the stop element 42 to be moved towards the releasing position.

In one form, the return retaining device 41 of the stop element 42 has a stiffness less than the stiffness of the return driving device 25 urging the activation member 2 towards the rest position.

The example provided has the advantage of being adequate for the low space requirement for the stop element 42 on the bracket 3 and the low space requirement for the driving element 22 of the activation member 2.

The electronic latch is configured to be activated, through the electronic device, by actuating the grip member 1 with the driving force. In case of loss of electrical energy, the grip member may be actuated by the driving force being higher than the predetermined driving force so as to permit the activation member 2 to reach the mechanical activating position and in particular pulling the Bowden cable connected to the latch.

The activation member 2 may then return to the rest position without being blocked by the stop element 42, due to the arrangement of the present disclosure.

Advantageously, the electronic handle of the example provided permits a good mechanical back-up, with a design applicable on standard activation member of the prior art.

In addition, the present disclosure may be implemented both on a horizontal and a vertical arrangement, with respect to the orientation of the corresponding vehicle.

Furthermore, the present disclosure has a reversible configuration allowing to open the latch many times, for example in case of losses of energy contrary to the prior solutions that are useable only once.

The solution is ergonomic and friendly as the user has to do a standard handle pulling movement, contrary to the prior complex solutions in which the user typically needs to check the vehicle’s technical manual.

Many modifications and variations will suggest themselves to those skilled in the art upon making reference to the foregoing illustrative forms, which are given by way of example only and which are not intended to limit the scope of the present disclosure, that being determined solely by the claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. Electronic handle for a vehicle door, the electronic handle comprising:
a grip member configured to cooperate with an activation member to activate a latch of the vehicle door and unlatch the door, the grip member and the activation member being rotatably mounted respectively about a grip axis and an activation axis;
an electronic device configured to electronically activate the latch of the vehicle door;
a bracket configured to receive the grip member and the activation member; and
a retainer mounted on the bracket and configured to rotate around a retaining axis and having a predetermined retaining force,
wherein the grip member is configured to rotate between:
a rest position in which the activation member is released from the grip member, and
a mechanical activation position in which the grip member cooperates with the activation member for activating the latch of the vehicle door in case of default of the electronic means, and
wherein the grip axis, the activation axis, and the retaining axis are parallel to each other,
wherein the activation member comprises a driving element and the retainer comprises a stop element, the driving element cooperating with the stop element such that when the grip member is pulled from the rest position to the mechanical activation position, the activation member is actuated according to a driving force, the driving element contacts the stop element and is retained by the stop element until the driving force exceeds the predetermined retaining force.

2. The electronic handle according to claim 1, wherein the activation member further has an electrical activation position between the rest position and the mechanical activation position, in which the activation member activates the electronic device for unlatching the door.

3. The electronic handle according to claim 2, wherein the stop element is configured to stop the activation member at the electrical activation position.

4. The electronic handle according to claim 1, wherein when the activation member moves from the rest position through the mechanical activation position, the driving element is configured to engage the stop element according to a first path until the driving element is blocked by the stop element,
wherein, when the driving force exceeds the predetermined retaining force, the driving element is configured to engage the stop element according to a second path, and
wherein a magnitude of the driving force necessary to move the activation member is less than the predetermined retaining force.

5. The electronic handle according to claim 1, wherein the stop element comprises a roller and the driving element comprises a surface configured to be in contact with the roller when the activation member moves from the rest position to the mechanical activation position.

6. The electronic handle according to claim 1, wherein when the activation member moves from the rest position through the mechanical activation position, the driving element is configured to engage the stop element according to a first path until the driving element is blocked by the stop element,
wherein, when the driving force exceeds the predetermined retaining force, the driving element is configured to engage the stop element according to a second path, and
wherein a magnitude of the driving force necessary to move the activation member is less than the predetermined retaining force,
wherein the stop element comprises a roller and the driving element comprises a surface configured to be in contact with the roller when the activation member moves from the rest position to the mechanical activation position, and
wherein the surface of the driving element is a cam surface having the first path and second path.

7. The electronic handle according to claim 1, wherein the predetermined retaining force is provided by a return retaining device associated with the reatiner.

8. The electronic handle according to claim 1, wherein the stop element is moveable such that the driving element moves the stop element when moving from the rest position to the mechanical activation position.

9. The electronic handle according to claim 8, wherein the stop element is free to rotate around a stopping axis parallel to the retaining axis when the driving element moves from the rest position to the mechanical activation position.

10. The electronic handle according to claim 1, wherein the grip member comprises a column.

11. The electronic handle according to claim 1, wherein the activation member is configured to electronically actuate the latch.

12. The electronic handle according to claim 1, further comprising a switch, wherein the activation member is configured to actuate the switch.

13. A vehicle comprising a door and the electronic handle according to claim 1, the electronic handle being fixed to the door.
